(19) United States
(12) Patent Application Publication
(10) Pub. No.: US 2012/0073450 A1
(43) Pub. Date: Mar. 29, 2012

(54) Steam mixer-cooker device

(75) Inventors: Isabelle CONSTANS, Mornant (FR); Alexandre NAOUN, Lyon (FR)

(73) Assignee: ALLEGRE PUERICULTURE, Saint Etienne (FR)

(21) Appl. No.: 13/007,165

(22) Filed: Jan. 14, 2011

(30) Foreign Application Priority Data
Sep. 24, 2010 (FR) 1057700

(51) Int. Cl. A47J 27/00

(52) U.S. Cl. 99/339; 99/348

(57) ABSTRACT

The invention concerns a device for heating, cooking and/or mixing food, comprising:
a steam generator (1),
a vessel (2) removably closed with a lid (3), and in which are arranged:
   a removable basket (21) with perforated base to contain food to be cooked or heated,
   a cutting blade (41) arranged underneath the basket, to mix food placed in the vessel,
a motor (4) to drive the blade in rotation;
   the device is noteworthy in that:
the removable basket comprises a central steam channel (22),
the lid comprises a radial steam channel (31), communicating with the central channel, and
the lid comprises an outer wall (35) distant from the radial channel.

### CROSS REFERENCE TO RELATED APPLICATIONS

This application claims priority to French Application 1057700 filed Sep. 24, 2010.

### BACKGROUND OF THE INVENTION

1. Field of the Invention

The present invention relates to the field of steam blenders/mixers and cookers.

2. Description of Related Art

A steam mixer-cooker device conventionally comprises a steam generator, a motor to drive an agitator and a vessel in which to place food ingredients.

To improve the cooking of food, steam mixer-cooker devices have been proposed in which the steam is brought to or fed into the base of the vessel.

Document U.S. Pat. No. 6,550,372 describes a food processing device comprising a base which receives a cooking vessel. A steam generator and a motor are housed in the base. The steam generator produces steam which is led into the bottom of the vessel.

Food processing devices in which steam is added via the bottom of the vessel are generally more complex to handle, notably due to the fact that all the constituent parts are arranged in the base. Also, feeding the steam via the bottom of the vessel increases risks of leakage, or clogging of steam-conveying channels.

Document FR 2 586 922 proposes a steam mixer-cooker in which the steam is led into the bottom of the vessel. The steam mixer-cooker comprises a motor housing containing an electric motor onto which a removable vessel is fitted. The electric motor drives a shaft and an agitator arranged inside the vessel.

The steam mixer-cooker comprises a lid intended to close the removable vessel. The lid comprises radial and central tubing connected to a steam generator. The tubing is arranged in the lid so as to convey steam from the generator towards the bottom of the vessel.

One drawback with this mixer-cooker is that the passing of steam through the central and radial tubing of the lid leads to an increase in lid temperature. There is therefore a risk of burns for users handling the lid of the mixer-cooker.

A further drawback is that food may obstruct the end of the central tubing when the lid is placed on the vessel containing food.

One of the objectives of the present invention is to propose a device which can overcome at least one of the above-mentioned shortcomings. More precisely, one purpose of the present invention is to propose a mixer-cooker device which can be handled risk-free, is easy to use, robust, user-friendly and allows steam to be fed into the bottom of the vessel for the steam cooking of food.

### DISCLOSURE OF THE INVENTION

For this purpose, according to the invention, there is provided a device for heating, cooking and/or mixing food, which comprises:
a steam generator,
a vessel that is removably closed with a lid (3), and in which are arranged:
   a removable basket with perforated base to contain food to be cooked or heated,
   a cutting blade arranged underneath the basket, to mix food placed in the vessel,
a motor to drive the blade in rotation;
   the device is noteworthy in that
the removable basket comprises a central steam channel,
the lid comprises a radial steam channel communicating with the central channel to convey the steam from an outlet of the steam generator to the central steam channel, and
the lid comprises an outer wall lying distant from the radial channel.

The presence of a lid comprising a radial channel arranged so as to cooperate with a central channel of a basket allows the device of the invention to convey the steam produced by the generator towards the bottom of the basket containing the food. This has the advantage of improving the quality of steam cooking of food. Also, the combining of the radial channel of the lid with the central channel of the basket limits the risks of leakage and clogging of the different steam channels when handling the device.

Additionally, the presence of a lid comprising an outer wall lying distant from the radial channel provides thermal insulation of the radial channel from the walls of the lid that are intended to be handled. This allows the temperature of the outer walls of the lid to be limited, and limits risks of burns for users when handling the lid.

Preferred, but non-limiting aspects of the device according to the invention are the following:
the lid comprises an orifice to evacuate steam;
the rim of the orifice is shaped so as to cause condensed steam to fall back into the vessel; for example the rim of the orifice is semi-spherical, the centre thereof lying closer to the basket than its upper part;
the rim of the orifice is shaped to avoid run—off of condensed steam over the outer wall of the lid; for example the rim of the orifice is of semi-spherical shape whose centre lies further distant from the basket than its upper part;
the rim of orifice may be of sandglass shape: this allows condensed steam to fall back into the vessel and also limits any condensed water vapour formed at the orifice from flowing along the outer wall of the lid;
the device comprises a second basket which is housed in the first;
the motor is capable of driving the blade at least at two different speeds;
the lid has an inner wall intended to come to lie opposite the basket and a side wall to connect the inner wall and outer wall, the side wall comprising at least one through opening; this allows facilitated evacuation and/or evaporation of any water which may enter between the outer and inner walls of the lid, notably when cleaning the device;
the radial channel is removable: this allows facilitated cleaning thereof;
the device comprises means to break up any water bubbles which may form in the steam generator; these means can be arranged in the radial channel or directly in the reservoir of the steam generator intended to receive the water to be evaporated; in either case, these means limit the passing of non-evaporated water from the generator to the vessel;
the means for breaking up water bubbles can be positioned facing the steam outlet of the steam generator; this allows a further reduction in the quantity of non-evaporated water passing from the steam generator towards the vessel;
the means for breaking up water bubbles may comprise a plate, for example extending perpendicular to an axis of the steam outlet of the steam generator;
the outlet of the steam generator consists of a tubular projection intended to cooperate with the radial channel of the lid, the tubular projection being arranged so that the outer face of the tubular projection cooperates with the inner wall of the radial channel; this allows facilitated connection of the generator with the lid; the tubular projection forms a seal between the radial channel and the steam generator; advantageously, the tubular projection can be made in a flexible material; this also allows limited wear of the different steam-conveying parts from the steam generator to the vessel; the tubular projection can be made in a memory elastic material for improved sealing between the steam generator and the radial channel of the lid;
the tubular projection is designed in a flexible material such as a polymer or silicone.

### PRESENTATION OF THE FIGURES

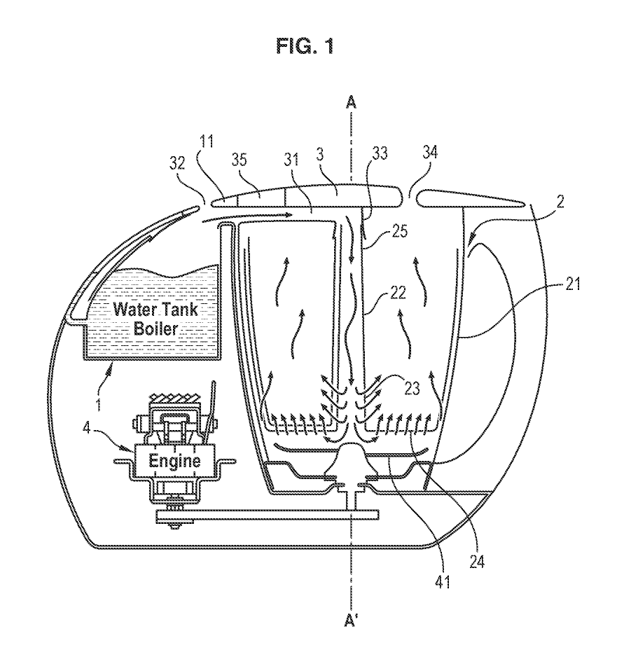

Other characteristics and advantages of the invention will become further apparent from the following description which is solely illustrative and is non-limiting, and is to be read with reference to FIG. 1 which illustrates a cross-sectional view of one embodiment of the device according to the invention.

### DESCRIPTION

A description will now be given of the steam mixer-cooker device according to the invention.

With reference to FIG. 1, the device comprises a steam generator 1, a vessel 2 removably closed by a lid 3, and a motor 4. The device also comprises a removable basket 21 and a blade 22 arranged in the vessel 2.

Preferably the vessel is removably attached to a base which forms a housing for the steam generator 1 and the motor 4

The steam generator 1 allows steam to be produced from water. An aperture 11 is provided in the supporting base to allow passing of steam from the steam generator 1 towards the vessel 2.

The steam generator comprises a reservoir intended to receive water to be evaporated, and means for heating thereof. Advantageously, the steam generator may also comprise means to break up bubbles formed in the reservoir when steam is generated. This limits the passing of a quantity of non-evaporated water from the steam generator towards the vessel. When the water contained in the reservoir is heated to form steam, bubbles form on the surface of the water. If the reservoir of the generator contains a large amount of water, bubbles may come into contact with the steam outlet 11 which means that a portion of non-evaporated water may circulate from the steam generator towards the vessel. By arranging means to break up bubbles formed in the steam generator, this can avoid bubbles coming into contact with the steam outlet 11 and hence avoids the risk of non-evaporated water passing from the steam generator into the vessel.

The person skilled in the art will appreciate that these means to break up bubbles can be adapted to any type of steam mixer-cooker device, irrespective of the variant of embodiment illustrated herein.

Preferably, the lid 3 of the device comprises a double wall which prevents the outer wall, intended to be handled by the user, from reaching too high temperature.

In some variants of embodiment, the lid 3 may additionally comprise an orifice 34 allowing steam to escape from the vessel 2. This prevents too strong pressure building up inside the vessel. It also allows the flow of steam to be directed towards the outside of the vessel 2 in a controlled manner.

Advantageously, the shape of the orifice provided in the lid is such that the water derived from condensation of steam on the lid falls back into the vessel. The shape of the orifice arranged in the lid can be also be provided so that

The lid 3 and the basket 21 may each comprise additional means allowing steam to be conveyed from the steam generator 1 towards the bottom of the vessel. By arranging additional steam-conveying means on the lid 3 and basket 21, it is possible to improve the ergonomics of the device.

In the embodiment illustrated in FIG. 1, the lid 3 comprises a radial channel 31 extending radially from the periphery of the lid 3 towards the centre thereof.

The peripheral end 32 of the radial, channel 31 extends along a radius of the lid 3. The central end 33 of the radial channel 31 extends crosswise to the plane of the lid 3. Therefore, when the lid 3 caps the vessel 2, the central end 33 of the radial channel 31 lies facing the bottom of the vessel 2.

The peripheral end 32 of the radial channel 31 is intended to lie opposite the aperture 11 arranged in the supporting base to allow steam to be conveyed from the steam generator 1 towards the centre of the lid 3.

In one embodiment, the aperture 11 comprises a tubular projection extending outwardly. This tubular projection may be arranged so that the outer face of the tubular projection cooperates with the inner wall of the radial channel. In addition, it may be provided that the shapes of the tubular projection and of the end of the radial channel are mating shapes, so as to limit steam leakage between the steam generator and the lid. For example, the shapes of the end of the tubular projection and of the radial channel may be matching truncated cone shapes.

In one variant of embodiment, the tubular projection is made in a flexible material. This facilitates the fitting of the tubular projection inside the radial channel.

The basket 21 comprises a channel 22 extending between the top and bottom of the basket. The basket channel has a proximal end 25 on the topside of the basket and a distal end on the bottom side of the basket.

Preferably, the proximal end 25 of the central channel 22, at the upper part of the basket 21, is defined by the free end of the side wall of the basket; further preferably, the proximal end 25 of the central channel 22 lies above the upper level of the basket. This allows the risk of channel clogging to be avoided, caused by food contained in the basket 21.

The central channel 22 is arranged so that the radial channel of the lid communicates with the central channel of the basket when the lid is placed on the vessel. This allows steam to be conveyed from the steam generator 1 towards the lower part of the vessel 2.

In the embodiment illustrated in FIG. 1, the basket channel is a central channel extending along an axis of revolution A-A′ of the basket 21. However, the reader will appreciate that the basket channel can be arranged at different positions of the basket. For example, in one embodiment, the basket channel extends along a wall thereof.

In all cases, the proximal end 25 of the channel 22 of the basket 21 is intended to cooperate with the central end 33 of the radial channel 31 when the vessel 2 is closed by the lid 3. This allows a continuous channel to be formed between the steam generator 1 and the bottom of the basket 21, so that steam is conveyed from the steam generator 1 as far as the lower part of the vessel 2.

The central 33 and proximal 25 ends of the channels 22, 31 may have different shapes. For example, the central 33 and proximal 25 ends may have mating truncated cone shapes. This allows facilitated fitting of the central 33 and proximal 25 ends into one another. It also guarantees close contact between the walls of the central 33 and proximal 25 ends, to limit leakage of steam at the connection between the radial channel 31 and the central channel 22.

The central channel 22 may have perforations 23 at the distal end for the passing of steam. The bottom of the basket 21 may also be perforated (perforations 24) to allow steam to rise towards the lid 3, passing through the bottom of the basket 21 and thereby cooking the food.

The device also comprises a cutting blade 41 arranged underneath the basket 21. The motor 4 arranged in the supporting base allows the blade 41 to be set in rotation to mix the food after cooking, or for heating thereof. Preferably, the motor is capable of driving the blade at least at two different speeds.

The operating principle of the device is as follows. Once the food to be cooked is arranged in the basket 21, the basket is placed in the vessel. The central channel of the basket extends vertically above the food. The device is then closed by positioning the lid on the vessel. The radial channel of the lid, whose end extends substantially along the axis of the central channel of the basket, fits into the central channel of the basket when the basket is placed in position. Once the device is closed, the steam generator generates steam which is conveyed towards the bottom of the basket where it escapes via the perforations in the channel and/or at the bottom of the basket. The steam rises in the direction of the lid, cooking the food, and escapes via the aperture of the lid. Once cooking of the food is completed, the basket is removed from the vessel to drain off any water which may have formed in the bottom of the vessel. The food is then transferred from the basket to the vessel, and control means are used to set the motor in operation which drives the cutting blade in rotation.

The reader will appreciate that numerous modifications can be made to the invention such as described in the foregoing without materially departing from the teachings of this document. Therefore, all such modifications are intended to be incorporated within the scope of the device such as defined in the appended claims.

1. Device for heating, cooking and/or mixing food, comprising:
a steam generator,
a vessel removably closed by a lid, in which are arranged:
a removable basket with a perforated bottom to contain food to be cooked or heated,
a cutting blade arranged underneath the basket, to mix the food placed in the vessel,
a motor to drive the blade in rotation;
wherein:
the removable basket comprises a central steam channel,
the lid comprises a radial steam channel, communicating with the central channel, to convey steam from an outlet of the steam generator towards the central steam channel, and
the lid comprises an outer wall distant from the radial channel.

2. The device according to claim 1, wherein the lid comprises an orifice to evacuate steam.

3. The device according to claim 2, wherein the rim of the orifice is shaped to cause condensed steam to fall back into the vessel.

4. The device according to claim 3, wherein the rim of the orifice is shaped to avoid run-off of condensed water vapour over the outer wall of the lid.

5. The device according to claim 1, which further comprises a second basket arranged above the first basket.

6. The device according to claim 1, wherein the motor is capable of driving the blade at least at two different speeds.

7. The device according to claim 1, wherein the lid comprises an inner wall intended to come to lie facing the basket, and a side wall to connect the inner wall and the outer wall, the side wall comprising at least one through opening.

8. The device according to claim 1, wherein the radial channel is removable.

9. The device according to claim 1, which comprises means to break up water bubbles which may form in the steam generator.

10. The device according to claim 9, wherein the means to break up water bubbles are positioned facing the steam outlet.

11. The device according to claim 9, wherein the means to break up bubbles comprise a plate.

12. The device according to claim 1, wherein the outlet of the steam generator comprises a tubular projection intended to cooperate with the radial channel of the lid, the tubular projection being arranged so that the outer face of the tubular projection cooperates with the inner wall of the radial channel.

13. The device according to claim 12, wherein the tubular projection is provided in a flexible material.

14. The device of claim 13 wherein the flexible material is a polymer.

15. The device of claim 14, wherein the polymer is a silicone type.
